(19) United States
(12) Patent Application Publication
(10) Pub. No.: US 2015/0189877 A1
(43) Pub. Date: Jul. 9, 2015

(54) Herbicidal Formulation

(71) Applicant: BASF SE, Ludwigshafen (DE)

(72) Inventors: Gerhard Schnabel, Elsenfeld (DE); Bernd Sievernich, Hassloch (DE); Torsten Meid, Einhausen (DE)

(21) Appl. No.: 14/412,056

(22) PCT Filed: Jul. 2, 2013
(86) PCT No.: PCT/EP2013/063901

§ 371 Date: Dec. 30, 2014

Related U.S. Application Data
(60) Provisional application No. 61/666,957, filed on Jul. 2, 2012.

(30) Foreign Application Priority Data
Jul. 2, 2012 (EP) 12174623.4

(51) Int. Cl. A01N 43/40; A01N 39/04

(52) U.S. Cl. CPC A01N 43/40; A01N 39/04

(57) ABSTRACT

A herbicide formulation comprising
a1) at least one herbicidal active substance from the class of the ACC inhibitors;
a2) optionally at least one safener;
a3) optionally at least one further herbicidal active substance other than (a1) and (a2);
b) one or more solvents of formula (I),

R—CO—NR¹R² (I)
where
R is a C₃-C₁₈-hydrocarbon radical,
R¹, R² are identical or different and are a C₁-C₁₄-hydrocarbon radical or a C₁-C₁₄-hydroxyhydrocarbon radical;
c) one or more aromatic solvents;
d) one or more surfactants from the group of the C₈-C₂₂-alkyl alcohols which are alkoxylated, where the terminal hydroxyl groups of these compounds are optionally capped by an alkyl, cycloalkyl or acryl radical having 1-24 carbon atoms;
e) one or more emulsifiers;
f) optionally one or more auxiliaries and
g) optionally water
   is suitable in particular for controlling undesired grasses.

The invention relates to a herbicide formulation comprising an ACCase inhibitor and an alkylcarboxamide, to a process for its preparation and to its use for controlling undesired vegetation.

Herbicides whose mechanism of action is based on inhibiting acetyl-CoA-carboxylase (ACC), also referred to as ACC inhibitors, have been employed successfully for many years for controlling undesired monocotyledonous plants such as grasses (graminids). An example of this class of active substances which may be mentioned is Clodinafop-propargyl, which is employed post-emergence as systemic grass herbicide (graminicide).

Although good results are already being obtained with the known formulations of these active substances, there is still room for improvement, for example as regards the consistency of action. In addition, these formulations frequently lose activity when combined with products against undesired dicotyledonous plants, in particular synthetic auxins such as dicamba and 2,4-D.

The object was therefore to develop further formulations for ACC inhibitors with the aid of which the abovementioned disadvantages are at least reduced.

It has been found that formulations of ACC inhibitors which, besides the active substance, comprise at least one C₃-C₁₈-alkylcarboxamide, C₈-C₂₈-alkyl alkoxylate, emulsifier and water-insoluble aromatic solvent, are suitable in particular for controlling undesired grasses.

Individual formulations which comprise individual ones of these components, in particular alkyl-carboxamides, are already known, see, for example, WO2011/003534, WO2010/145772, WO2007/140332, WO2006/040022, WO2005/104844 and US2009/0215797; however, there is no indication of the component combination according to the invention.

Subject matter of the invention is therefore a herbicide formulation comprising
a1) at least one herbicidal active substance from the class of the ACC inhibitors, such as aryloxyphenoxypropionates, in particular Clodinafop-propargyl;
a2) optionally at least one safener;
a3) optionally at least one further herbicidal active substance other than (a1) and (a2);
b) one or more solvents of formula (I)

R—CO—NR¹R² (I)
in which
R is a C₃-C₁₈-hydrocarbon radical such as C₃-C₁₈-alkyl, C₃-C₁₈-alkenyl, C₃-C₁₈-alkynyl, C₃-C₁₈-cycloalkyl, C₃-C₁₈-cycloalkenyl or C₃-C₁₈-cycloalkynyl,

R¹, R² are identical or different and are a C₁-C₁₄-hydrocarbon radical such as C₁-C₁₄-alkyl, C₁-C₁₄-alkenyl, C₁-C₁₄-alkynyl, C₄-C₁₄-cycloalkyl, C₄-C₁₄-cycloalkenyl or C₄-C₁₄-cycloalkynyl, or a C₁-C₁₄-hydroxyhydrocarbon radical such as C₁-C₁₄-hydroxyalkyl, C₁-C₁₄-hydroxyalkenyl, C₁-C₁₄-hydroxyalkynyl, C₄-C₁₄-hydroxycycloalkyl, C₄-C₁₄-hydroxycycloalkenyl or C₄-C₁₄-hydroxycycloalkynyl;
c) one or more aromatic solvents such as toluene, xylenes, naphthalene derivatives, mixtures of C₆-C₁₆-aromatics, or chlorobenzene and anisaldehyde acetate;
d) one or more surfactants from the group of the C₈-C₂₂-alkyl alcohols which are alkoxylated, for example with 1-60 alkylene oxide units, preferably 1-60 BO and/or 1-30 PO and/or 1-15 BO in any order, with the terminal hydroxyl groups of these compounds optionally being capped by an alkyl, cycloalkyl, acyl or carboxylate (COOR) radical having 1-24 carbon atoms;
e) one or more emulsifiers, such as ionic emulsifiers (e1) and nonionic emulsifiers (e2);
f) optionally one or more auxiliaries, for example antifoams and/or compatibilizers, and
g) optionally water.

Another subject matter of the invention is a process for the preparation of a herbicide formulation according to the invention, where the abovementioned components are mixed with each other.

Subject matter of the invention is likewise the use of the herbicide formulations according to the invention for controlling undesired vegetation and a method of controlling undesired vegetation, where an effective amount of a herbicide formulation according to the invention is applied to the undesired plants or the loci where they occur.

Advantages of the formulation according to the invention are higher activity combined with good selectivity,

good miscibility, tank mix compatibility, good stability of the spray liquors over a wide concentration range, good physical and chemical stability, low-temperature stability and advantageous spraying behavior. When the ACC inhibitors employed in accordance with the invention are combined with dicot herbicides, such as auxin derivatives, less antagonism is observed, and, indeed, in some cases a synergistic effect on the activity of co-applied herbicides, such as Dicamba, may be observed.

The preferred, especially preferred and particularly preferred features described hereinbelow should be interpreted such that the preferences apply either independently of one another or in combination with each other.

Preferably, the herbicide formulation according to the invention has the following composition (in % by weight):

(a) 2-60, preferably 2.5-45, especially preferably 3.75-25,
(a1) 2-30, preferably 2-16, especially preferably 3-10,
(a2) 0-10, preferably 0.5-4, especially preferably 0.75-2.5,
(a3) 0-50, preferably 0-25, especially preferably 0-12.5,
(b) 5-60, preferably 7.5-45, especially preferably 10-35,
(c) 5-60, preferably 7.5-45, especially preferably 10-35,
(d) 5-60, preferably 7.5-45, especially preferably 10-35,
(e) 3-30, preferably 3-20, especially preferably 6-18
(e1) 0-30, preferably 0-20, especially preferably 3-15
(e2) 0-30, preferably 0-20, especially preferably 3-15,
(f) 0-20, preferably 0.01-10, especially preferably 0.5-6,
(f1) 0-10 compatibilizer, preferably 0.5-10, especially 1-5,
(f2) 0-5 antifoam, preferably 0.02-2, especially 0.05-2 and
(g) 0-50, preferably 0-5, especially preferably 0-1.

In a preferred embodiment, the herbicide formulation according to the invention is composed of components (a)-(g). In a further embodiment, the herbicide formulation according to the invention is composed of components (a)-(f).

The herbicide formulation according to the invention comprises at least one herbicidal active substance from the group of the ACC inhibitors (a1), preferably from the class of the aryloxyphenoxypropionates (FOPs), such as clodinafop-propargyl, cyhalofop-butyl, diclofop-methyl, diclofop-P-methyl, fenoxaprop-P-ethyl, fluazifop-butyl, fluazifop-P-butyl, haloxyfop, haloxyfop-P, haloxyfop-B-methyl, propaquizafop, quizalofop, quizalofop-ethyl, quizalofop-P, quizalofop-P-ethyl and quizalofop-P-tefuryl; of the cyclohexanedione oximes (DIMs), such as alloxydim, butroxydim, clethodim, cycloxydim, profoxydim, sethoxydim, tepraloxydim and tralkoxydim; and the phenylpyrazolines (DENs), such as pinoxaden. Especially preferred are FOPs, with clodinafop-propargyl being particularly preferred.

Preferably, the herbicide formulation according to the invention comprises one or two, especially preferably one, ACC inhibitor.

In particular in the case of the FOPs, the herbicide formulation according to the invention preferably comprises one or more safeners (a2), preferably from the group consisting of cloquintocet-mexyl, fenchlorazole-ethyl and mefenpyr-diethyl, especially preferably cloquintocet-mexyl.

If the herbicide formulation according to the invention comprises one or more safeners, this is preferably one safener.

Preferred as a combination of ACC inhibitor and safener is the combination clodinafop-propargyl/cloquintocet-mexyl.

In a further embodiment, the herbicide formulation according to the invention comprises, besides at least one ACC inhibitor and optionally at least one safener, at least one further herbicidal active substance a3), preferably from the group of the (synthetic) auxins, such as Dicamba or 2,4-D, and their salts, for example organic ammonium salts; 4-HPPD inhibitors such as topramezone, benzobicyclon, benzofenap, bicyclopyrone, clomazone, isoxalflutole, pyrasulfofole, pyrazolinate, pyrazoxyten, mesotrione, sulcotrione, tefuryltrione and tembotrione; benzonitriles such as bromoxynil and ioxynil; and/or sulfonylureas such as amidosulfuron, azimsulfuron, bensulfuron, chlorimuron-ethyl, chlorosulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, triberuron, trifloxysulfuron, triflusulfuron, tritosulfuron, bensulfuron-methyl, chlorimuron, ethametsulfuron, ethametsulfuron-methyl, flupyrsulfuron-methyl-sodium, halosulfuron-methyl, iodosulfuron-methyl-sodium, iofensulfuron, iofensulfuron-sodium, metazosulfuron, metsulfuron, orthosulfamuron, primisulfuron-methyl, propyrisulfuron, pyrazosulfuron-ethyl, sulfometuron-methyl, thifensulfuron-methyl, tribenuron-methyl, triflusulfuron-methyl and 1-((2-chloro-6-propylimidazo[1,2-b]pyridazin-3-yl)sulfonyl)-3-(4,6-dimethoxypyrimidin-2-yl)urea.

Preferred as component a3) are (synthetic) auxins, in particular dicamba and 2,4-D, and 4-HPPD inhibitors

Active substances from groups (a1), (a2) and (a3) are commercially available and are known for example from the specifications mentioned in each case hereinabove and from “The Pesticide Manual”, 15th edition, 2009, The British Crop Protection Council, “Agricultural Chemicals Book II—Herbicides—”, by W. T. Thompson, Thompson Publications, Fresno Calif., USA 1990 and “Farm Chemicals Handbook '90”, Meister Publishing Company, Willoughby Ohio, USA, 1990.

The herbicide formulation according to the invention comprises, as solvent, one or more amides of the formula (I)

R—CO—NR¹R² (I)
in which
R is a C₃-C₁₈-hydrocarbon radical such as C₃-C₁₈-alkyl, C₃-C₁₈-alkenyl, C₃-C₁₈-alkynyl, C₃-C₁₈-cycloalkyl, C₃-C₁₈-cycloalkenyl or C₃-C₁₈-cycloalkynyl,
R¹, R² are identical or different, preferably identical, and are a C₁-C₁₄-hydrocarbon radical such as C₁-C₁₄-alkyl, C₁-C₁₄-alkenyl, C₁-C₁₄-alkynyl, C₄-C₁₄-cycloalkyl, C₄-C₁₄-cycloalkenyl or C₄-C₁₄-cycloalkynyl, or a C₁-C₁₄-hydroxyhydrocarbon radical such as C₁-C₁₄-hydroxyalkyl, C₁-C₁₄-hydroxyalkenyl, C₁-C₁₄-hydroxyalkynyl, C₄-C₁₄-hydroxycycloalkyl, C₄-C₁₄-hydroxycycloalkenyl or C₄-C₁₄-hydroxycycloalkynyl.

In formula (I), the hydrocarbon radicals R, R¹ and R² and the hydroxyhydrocarbon radicals R¹ and R² may be straight-chain, branched or cyclic. The hydrocarbon radicals R, R¹ and R² and the hydroxyhydrocarbon radicals R¹ and R² may be substituted. Substituted hydrocarbon radicals and hydroxyhydrocarbon radicals, for example substituted alkyl, alkenyl, alkynyl, cycloalkyl, cycloalkenyl, cycloalkynyl, hydroxyalkyl, hydroxyalkenyl, hydroxyalkynyl, are, for example, a substituted radical which is derived from the substituted parent structure, with the substituents representing for example one or more, preferably 1, 2 or 3, radicals selected from the group consisting of halogen, alkoxy, haloalkoxy, alkylthio, amino, nitro, carboxy, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkyl-sulfonyl, haloalkylsulfonyl and, in the case of cyclic radicals, also alkyl, hydroxyl and haloalkyl, and unsaturated aliphatic radicals which correspond to the abovementioned saturated hydrocarbon-containing radicals, such as alkenyl, alkynyl, alkenyloxy, alkynyloxy and the like.

If the alkyl radicals R, R¹ and R² and the hydroxyalkyl radicals R¹ and R² in formula (I) are substituted, then they are substituted by C₂-C₁₉-alkenyl, C₂-C₁₉-alkynyl, C₄-C₁₉-cycloalkyl, C₄-C₁₉-cycloalkenyl or C₄-C₁₉-cycloalkynyl.

Alkyl radicals, also in the composite meanings such as alkoxy, haloalkyl and the like, represent, unless otherwise specified, for example methyl, ethyl, n- or iso-propyl, n-, iso-, tert- or sec-butyl, pentyl, hexyl such as n-hexyl, iso-hexyl and 1,3-dimethylbutyl, or heptyl such as n-heptyl, 1-methylhexyl and 1,4-dimethylpentyl; alkenyl and alkynyl radicals have the meanings of the unsaturated radicals which are possible and which correspond to the alkyl radicals; alkenyl represents, for example, allyl, 1-methylprop-2-en-1-yl, 2-methyl-prop-2-en-1-yl, but-2-en-1-yl, but-3-en-1-yl, 1 methyl-but-3-en-1-yl and 1-meth-but-2-en-1-yl; alkynyl represents, for example, propargyl, but-2-yn-1-yl, but-3-yn-1-yl, 1-methyl-but-3-yn-1-yl.

Cycloalkyl represents a carbocyclic unsaturated ring system, for example cyclopropyl, cyclobutyl, cyclopentyl or cyclohexyl. Cycloalkenyl and cycloalkynyl represent the corresponding unsaturated ring systems.

Examples of alkyl radicals R are propyl such as n-propyl or iso-propyl, butyl such as n-butyl or branched pentyl such as isopentyl or neopentyl, hexyl such as n-hexyl or branched hexyl, heptyl such as n-heptyl or branched heptyl, octyl such as n-octyl or branched octyl such as isooctyl, nonyl such as n-nonyl or branched nonyl, decyl such as n-decyl or branched decyl, undecyl such as n-undecyl or branched undecyl, dodecyl such as n-dodecyl or branched dodecyl, tridecyl such as n-tridecyl or branched tridecyl.

Examples of alkyl radicals R¹ and R² are methyl, ethyl, propyl such as n-propyl or iso-propyl, butyl such as n-butyl or branched butyl such as sec-butyl, iso-butyl or tert-butyl, pentyl such as n-pentyl or branched pentyl such as isopentyl or neopentyl, hexyl such as n-hexyl or branched hexyl, heptyl such as n-heptyl or branched heptyl, octyl such as n-octyl or branched octyl such as isooctyl, nonyl such as n-nonyl or branched nonyl, decyl such as n-decyl or branched decyl, undecyl such as n-undecyl or branched undecyl, dodecyl such as n-dodecyl or branched dodecyl, tridecyl such as n-tridecyl or branched tridecyl, and the corresponding hydroxyalkyl radicals such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxydecyl, hydroxyundecyl, hydroxydodecyl or hydroxytridecyl.

Preferred solvents of the formula (I) are those in which R═C₆-C₁₂-alkyl, preferably C₈-C₁₀-alkyl, and R₁, R₂ are identical or different, preferably identical, and are C₁-C₆-alkyl (for example methyl, ethyl, propyl, such as n-propyl or iso-propyl, butyl such as n-butyl, or branched butyl such as sec-butyl, iso-butyl or tert-butyl, pentyl such as n-pentyl or branched pentyl such as isopentyl or neopentyl, hexyl such as n-hexyl or branched hexyl), C₄-C₁₀-cycloalkyl (for example cyclobutyl, cyclopentyl or cyclohexyl) or C₁-C₆-hydroxyalkyl.

Other preferred solvents are those of the formula (I) in which R═C₆-C₁₂-alkyl, preferably C₈-C₁₂-alkyl, and R¹═R² and is C₁-C₆-alkyl, preferably methyl.

Solvents b) which are present in the herbicide formulation according to the invention are, for example, decanoic acid dimethylamide (for example available as Genagen® 4296 from Clariant), mixtures of C₈/C₁₀-fatty acid dimethylamides (for example available as Genagen® 4166 and Genagen® 4231 from Clariant) and dodecanoic acid dimethylamide, for example available as Agnique® AMD 12 from BASF SE).

In one embodiment, the herbicide formulation according to the invention comprises a compound of the formula (I). In a further preferred embodiment, the herbicide formulation according to the invention comprises more than one, typically 2-4, compounds of the formula (I). In particular in the case when amides of fatty acids from natural raw materials are employed, mixtures of compounds of the formula (I) will usually be present, with one compound frequently dominating.

The herbicide formulation according to the invention comprises one or more water-insoluble aromatic solvents as component (c).

“Water-insoluble” means, according to the invention, a water solubility of less than 1 g/l at 25° C. and atmospheric pressure, in particular less than 0.2 g/l.

Preferred water-insoluble aromatic solvents are aromatic hydrocarbons such as toluene, xylenes and naphthalene derivatives, in particular 1-methylnaphthalene, 1-methylnaphthalene, mixtures of C₆-C₁₆-aromatics such as, for example, the Solvesso series (Esso) with the types Solvesso® 100 (b.p. 162-177° C.), Solvesso® 150 (b.p. 187-207° C.) and Solvesso® 200 (b.p. 219-282), Solvesso 200 ND, Solvesso 150 ND, and halogenated aromatic hydrocarbons such as chlorobenzene or anisaldehyde acetals such as anisaldehyde dimethyl acetal.

Preferred aromatic solvents (c) are mixtures of C₆-C₁₆-aromatics, in particular those whose naphthalene content has been reduced (<1%), and anisaldehyde dimethyl acetal.

The herbicide formulation according to the invention comprises, as component d) one or more surfactants from the group of the C₈-C₂₂-alkylalcohols which are alkoxylated, for example with 1-60 alkylene oxide units, preferably 1-60 EO and/or 1-30 PO and/or 1-15 BO, in any order, with the terminal hydroxyl groups of these compounds optionally being capped by an alkyl, cycloalkyl or acryl radical having 1-24 carbon atoms.

Examples of such compounds are: Plurafac® and Lutensol®A, AT, ON, TO products from BASF, Genapol®C, L, O, T, DU, UDD, X products from Clariant, Marlipal®24 and O13 products from Condea, Dehypon® products from Henkel, Ethylan® products from Akzo-Nobel, such as Ethylan®CD 120.

Preferred as component (d) are alkyl alkoxylates of the formula (II)

R³—O—[R⁴O]ₘR⁵ (II)
where
R³ is a linear or branched, saturated or unsaturated (C₈-C₂₂)-hydrocarbon radical which is unsubstituted or substituted by one or more hydroxyl groups;
R⁴ is an ethylene, propylene or butylene group or a mixture of two or three of the abovementioned groups;
R⁵ is H, (C₁-C₂₄)-alkyl, (C₂-C₂₄)-acyl, (C₃-C₈)-cycloalkyl, and
m is a natural number from 3 to 100.

The symbols in formula (II) have especially preferably the following meanings:

R³ is preferably C₁₂-C₁₆-alkyl, especially preferably a C₁₂-C₁₄-alkyl mixture and very especially preferably C₁₃-alkyl.
R⁴ is preferably ethyl and/or propyl, especially preferably and very especially preferably ethyl.
R⁵ is preferably H, methyl, tert-butyl, —COOMe or COMe, especially preferably and very especially preferably H or methyl.
m is preferably 4 to 20, especially preferably 5 to 15 and very especially preferably 6 to 10. Preferred, especially preferred and very especially preferred are also compounds of the formula (II) in which all of R³, R⁴, R
and m have in each case the preferred, especially preferred and very especially preferred meanings.

The herbicide formulation according to the invention comprises, as component (e), one or more emulsifiers, preferably from the groups consisting of ionic emulsifiers (e1) and/or nonionic emulsifiers (e2):

Ionic emulsifiers (e1) are preferably anionic surfactants, for example alkali metal, alkaline-earth metal or ammonium salts of the fatty acids, such as potassium stearate, alkyl sulfates, alkyl ether sulfates, alkyl- or isoalkylsulfonates, alkylbenzenesulfonates such as sodium dodecylbenzenesulfonate and calcium dodecylbenzenesulfonate, alkylnaphthalenesulfonates, alkyl methyl ester sulfonates, acyl glutamates, alkylsuccinic acid ester sulfonates, sarcosinates such as sodium lauroyl sarcosinate and taurates, and mixtures of more than one ionic emulsifiers.

Preferred ionic emulsifiers (e1) are the salts of the alkylbenzenesulfonates and the alkyl-sulfosuccinates. Especially preferred ionic emulsifiers are the salts of alkylbenzenesulfonic acids, especially the calcium salt of dodecylbenzenesulfonic acid and the sodium salt of dioctylsulfosuccinate, in particular the calcium salt of dodecylbenzenesulfonic acid.

Especially preferred is calcium p-dodecylphenylsulfonate, which is available for example from BASF SE under the name Wettol®EM 1.

Suitable nonionic emulsifiers (e2) are, for example, alkoxylated animal or vegetable fats and oils such as corn oil ethoxylates, castor oil ethoxylates, tallow fat ethoxylates, glycerol esters such as glycerol monostearate, fatty alcohol alkoxylates and oxoalcohol alkoxylates, fatty acid alkoxylates such as oleic acid ethoxylates, alkylphenol alkoxylates such as isononyl, isooctyl, tributyl, tristearylphenol ethoxylates, fatty amine alkoxylates, fatty acid amide alkoxylates, sugar surfactants such as sorbitan fatty acid esters (sorbitan monooleate, sorbitan tristearate), polyoxyethylene sorbitan fatty acid esters, alkylpolyglycosides, N-alkylglucomannides, alkyl methyl sulfoxides, alkyldimethylphosphine oxides such as tetradecyldimethylphosphine oxide, and mixtures of such nonionic emulsifiers.

Preferred nonionic emulsifiers are ethoxylated or propoxylated, naturally occurring carboxylic acids or alcohols, especially ethoxylated oils such as castor oil ethoxylate with 36 to 50 ethylene oxide units (available for example from BASF SE under the name Wettol®EM 31).

The herbicide formulation according to the invention preferably comprises at least one emulsifier from group (e1) and at least one emulsifier from group (e2). In this case, the weight ratio of the components (e1):(e2) is preferably 0.1-10:1.

Suitable auxiliaries (f) are usually solvents or solubilizers, penetrants, protective colloids, stickers, thickeners, humectants, compatibilizers, bactericides, antifreeze agents, antifoams, colorants, adhesives and binders.

Suitable further solvents besides components (b) and (c) are, optionally, nonpolar or polar solvents such as mineral or vegetable oils, aliphatic hydrocarbons, lactic esters, carboxylic esters, DMSO, gamma-butyrolactone, propylene carbonate, glycerol, propylene glycol and/or ethylene glycol.

Suitable thickeners are preferably polysaccharides (for example xanthan gum, carboxymethyl-cellulose), inorganic clays (organic-modified or unmodified), polycarboxylates and silicates.

Suitable bactericides are, preferably, bronopol and isothiazolin derivatives such as alkylisothiazolinones and benzisothiazolinone.

Suitable antifreeze agents are, preferably, ethylene glycol, propylene glycol, urea and glycerol.

Examples of suitable humectants are glycerol or sugar syrups, such as corn syrup, which is obtained from maize (available for example from Cargill, USA).

Examples of suitable compatibilizers are dipropylene glycol, monopropylene glycol, butyl diglycol or polyethylene glycol with an M_{w} of 200, for example obtainable as Pluriol® E 200 from BASF SE.

Suitable antifoams are, preferably, silicones, long-chain alcohols and salts of fatty acids.

Suitable colorants (for example in red, blue and green) are, preferably, pigments, which are sparingly soluble in water, and dyes, which are water-soluble. Examples are inorganic coloring agents (for example iron oxide, titanium oxide, iron hexacyanoferrate) and organic coloring agents (for example alizarin, azo and phthalocyanin coloring agents).

Suitable stickers or binders are, preferably, polyvinylpyrrolidones, polyvinyl acetates, polyvinyl alcohols, polyacrylates, biological or synthetic waxes and cellulose ethers.

It is preferred to prepare the herbicide formulation according to the invention as solutions, such as emulsion concentrates (EC), microemulsion or microemulsion concentrate, or emulsion (emulsion concentrate EW) or oil dispersion (OD). EC are especially preferred.

Examples for the preparation of preferred formulations are:

Emulsion Concentrates (EC) and Microemulsion Concentrates

The components (a), (b) and (d)-(f) are dissolved in the organic solvent (c) to 100% by weight. Dilution with water gives an emulsion or microemulsion as spray liquor.

Emulsions

Components (a), (b) and (d)-(f) are dissolved in 20-40% by weight of water-insoluble organic solvent (c). Using an emulsifying mill, this mixture is introduced into water to 100% by weight and processed to give a homogeneous emulsion. The subsequent dilution with water gives an emulsion as spray liquor.

Microemulsions

Components (a) and (e)-(f) are added to 5-30% by weight of an organic solvent mixture (b) and (c), 10-25% by weight of a surfactant mixture (d) and water to 100%. This mixture is stirred for 1 h, which results in the spontaneous generation of a thermodynamically stable microemulsion.

When used in plant protection, the application rates of the active substances (for example “fops”) generally amount to from 0.001 to 2 kg per ha, preferably to from 0.005 to 2 kg per ha, especially preferably from 0.02 to 0.5 kg per ha and in particular from 0.03 to 0.20 kg per ha, depending on the nature of the desired effect.

Various types of oils, wetters, auxiliaries, fertilizers or micronutrients and also further pesticides (for example herbicides, insecticides, fungicides, growth regulators, safeners) may be added to the compositions according to the invention, either as a premix or optionally only just before use (tank mix). These agents can be admixed to the compositions according to the invention in a weight ratio of from 1:100 to 100:1, preferably 1:10 to 10:1.

Further pesticides which are suitable are, for example, pesticides comprising at least one active substance selected from the group of the herbicides, safeners, fungicides, insecticides, nematicides and/or growth regulators. Preferred pesticides are herbicides, fungicides, insecticides and growth regulators. Mixtures of pesticides from two or more of the abovementioned classes may also be used. A person skilled in the art is familiar with such pesticides, which can be found, for example, in the Pesticide Manual, 15th Ed. (2009), The British Crop Protection Council, London. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ethers, glycins, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils and ureas. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazins, METI acaricides, and insecticides such as chloropicrin, pymetrozin, flonicamid, clofentezin, hexythiazox, etoxazol, diafenthiuron, propargit, tetradifon, chlorfenapyr, DNOC, buprofezin, cyromazin, amitraz, hydramethylnon, acequinocyl, fluacrypyrim, rotenone or their derivatives. Suitable fungicides are fungicides from the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzylcarbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenylcrotonates, dithiocarbamates, dithiolanes, ethylphosphonates, ethylaminothiazolcarboxamides, guanidines, hydroxy-(2-amino-)pyrimidines, hydroxyanilides, imidazoles, imidazolinones, inorganic compounds, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines and triazoles.

The user will usually apply the composition according to the invention from a predosing device, a knapsack sprayer, a spray tank, a spray plane or an irrigation system. Usually, the agrochemical composition is diluted to the desired application concentration with water, buffer and/or further auxiliaries, whereby the ready-to-use spray mixture or agrochemical composition of the invention is obtained. Usually, 20 to 2000 liters, preferably 50 to 400 liters, of the ready-to-use spray liquor will be applied per hectare of utilizable agricultural area.

According to one embodiment, individual components of the formulation according to the invention, such as parts of a kit or parts of a binary or ternary mixture, may be mixed by the user himself in a spray tank, and further auxiliaries may optionally be added.

In a further embodiment, either individual components of the formulation according to the invention or partly premixed components may be mixed by the user in a spray tank, and further auxiliaries and additives may optionally be added.

In a further embodiment, either individual components of the formulation according to the invention or partly premixed components, for example components comprising herbicides (a) and/or further active substances, may be applied jointly (for example after being mixed in the tank) or in succession.

The herbicide formulation according to the invention is suitable as herbicide. It effects a very good control of vegetation on noncrop areas, especially at high application rates. In crops such as cereals, in particular wheat, rye, triticale and in rice, soya and cotton it is active against broad-leaved weeds and grass weeds without inflicting any substantial damage to the crop plants. This effect is observed mainly at low application rates.

Grass weeds which can be controlled with the composition according to the invention are, for example, Aegilops cylindrica, Alopecurus myosuroides, Agrostis stolonifera, Agropyron repens, Apera spica-venti, Avena fatua, Avena ludoviciana, Avena sterilis, Brachiaria brizantha, Brachiaria plantaginea, Brachiaria platyphylla, Brachiaria decumbens, Bromus arvensis, Bromus inermis, Bromus mollis, Bromus secalinus, Bromus sterilis, Bromus tectorum, Cenchrus echinatus, Cenchrus incertus, Cynodon dactylon, Dactyloctenium aegyptium, Digitaria adscendens, Digitaria ciliaris, Digitaria horizontalis, Digitaris ischaemum, Digitaria sanguinalis, Echinochloa colonum, Echinochloa crus-galli, Echinochloa crus-pavonis, Echinochloa spp., Eleusine indica, Eriochloa gracilis, Eriochloa villosa, Imperata cylindria, Ischaemum rugosum, Leptochloa chinensis, Leptochloa fascicularis, Leptochloa filiformis, Lolium multiflorum, Lolium perenne, Lolium rigidum, Lolium temulentum, Panicum capillare, Panicum dichotomiflorum, Panicum maximum, Panicum miliaceum, Panicum repens, Panicum texanum, Phalaris brachystachys, Phalaris canariensis, Phalaris minor, Poa annua, Poa trivialis, Roettboellia exaltata, Setaria faberi, Setaria italica, Setaria lutescens (=glauca), Setaria verticilliata, Setaria viridis, Setaria spec., Sorghum bicolor, Sorghum halepense.

It is preferred to control Alopecorus myosuroides, Avena fatua, Avena ludoviciana, Avena sterilis, Lolium multiflorum, Lolium perenne, Lolium rigidum, Lolium temulentum, Phalaris brachystachys, Phalaris canariensis, Phalaris minor, Roettboellia exaltata, Setaria faberi, Setaria italica, Setaria lutescens (=glauca), Setaria verticilliata, Setaria viridis and/or Setaria spec. with the composition according to the invention.

Depending on the application method in question, the herbicide formulation according to the invention can additionally be employed in a number of other crop plants for eliminating undesired plants. Examples of suitable crops are the following:

Allium cepa, Ananas comosus, Arachis hypogaea, Asparagus officinalis, Avena satva, Beta vulgaris spec. altissima, Beta vulgaris spec. rapa, Brassica napus var. napus, Brassica napus var. napobrassica, Brassica rapa var. silvestris, Brassica nigra, Brassica oleracea, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Ribes sylvestre, Ricinus communis, Saccharum officinarum, Secale cereale, Sinapis albal, Solanum tuberosum, Sorghum bicolor (S. vulgare), Theobroma cacao, Trifolium pratense, Triticale, Triticum aestivum, Triticum durum, Vicia faba, Vitis vinifera and Zea mays.

In addition, the composition according to the invention can also be used in crops which tolerate the effect of herbicides as the result of breeding, including recombinant methods.

The invention is illustrated in greater detail by the examples without being limited thereby.

### EXAMPLES

### Preparation Examples

The following herbicide formulations were prepared:

Table 1 Formulations according to the invention and comparative examples

TABLE 1

| Com- | | | | |
|---|---|---|---|---|
| po- | | | | |
| nent | Example 1 | Example 2 | Comparative example 1 | Example 3 |
| (a1) | clodinafop-propargyl 60 g/l | clodinafop-propargyl 60 g/l | clodinafop-propargyl 60 g/l | clodinafop-propargyl 60 g/l |
| (a2) | cloquintocel-mexyl 15 g/l | cloquintocel-mexyl 15 g/l | cloquintocel-mexyl 15 g/l | cloquintocel-mexyl 15 g/l |
| (a3) | — | — | — | — |
| (b) | decanoic acid dimethylamide* | decanoic acid dimethylamide* | — | decanoic acid dimethylamide* |
| | 300 g/l | 200 g/l | | 200 g/l |
| (c) | mixture of C₆-C₁₀-aromatics** | mixture of C₆-C₁₀-aromatics** | mixture of C₆-C₁₀-aromatics** | mixture of C₆-C₁₀-aromatics** |
| | to 1 l | to 1 l | to 1 l | to 1 l |
| (d) | ethoxylate of alkylpolyethylene | ethoxylate of alkylpolyethylene | ethoxylate of alkylpolyethylene | ethoxylate of alkylpolyethylene |
| | glycol ethers based on C₁₀- | glycol ethers based on C₁₀- | glycol ethers based on C₁₀- | glycol ethers based on C₁₀- |
| | Guerbet-alcohol*** 100 g/l | Guerbet-alcohol*** 300 g/l | Guerbet-alcohol*** 100 g/l | Guerbet-alcohol*** 300 g/l |
| | alkoxylation product of linear fatty | | alkoxylation product of linear fatty | alkoxylation product of linear fatty |
| | alcohols with ethylene oxide and | | alcohols with ethylene oxide and | alcohols with ethylene oxide and |
| | higher alkylene oxides**** 100 g/l | | higher alkylene oxides**** 100 g/l | higher alkylene oxides**** 100 g/l |
| (e1) | calcium p- | calcium p- | calcium p- | calcium p- |
| | dodecylphenylsulfonate***** | dodecylphenylsulfonate***** | dodecylphenylsulfonate***** | dodecylphenylsulfonate***** |
| | 80 g/l | 120 g/l | 80 g/l | 80 g/l |
| (e2) | ethoxylated p-nonylphenol****** | ethoxylated p-nonylphenol****** | ethoxylated p-nonylphenol****** | ethoxylated p-nonylphenol****** |
| | 120 g/l | 80 g/l | 120 g/l | 120 g/l |
| (f) | — | — | — | propylene glycol 50 g/l |
| (g) | — | — | — | |

*= Genagen ®4296,
**= Solvesso ®200ND,
***= Lutensol ®T08,
****= Plurafac ®LF1300,
*****= Calsogen ®AR 100 ND,
******= Emulan ®EL40

### II Use Examples

It was possible to demonstrate the herbicidal activity of the herbicide formulation according to the invention by greenhouse experiments:

The crop containers used were plastic pots containing loamy sand with approximately 3.0% humus as the substrate. The seeds of the test plants were sown separately by species.

For the purposes of the pest-emergence treatment, the test plants were first grown to a height of 3 to 15 cm, depending on their growth habit, and then treated with the herbicidal composition. The test plants were grown either by sowing them directly into the test containers or by sowing the test plants into seed trays and subsequently transplanting them into the test containers a few days before the treatment.

Depending on the species, the plants were kept at temperatures of 10-25° C. or 20-35° C. The test period extended over 2 to 4 weeks. During this time, the plants were tended, and their response to the individual treatments was evaluated.

The activity of the herbicidal composition on the test plants was assessed by comparing them directly with untreated test plants using a percentage scale (0 to 100%). In this context, 100% means no emergence of the plants, or complete destruction of at least the aerial parts, and 0% means no damage or normal course of growth.

The activity of the herbicide formulation according to the invention of Example 1 against various test plants was compared with the activity of Comparative example 1 (Table 2).

TABLE 2

| | Appli- | | | | |
|---|---|---|---|---|---|
| | cation | | | | |
| | rate | Harmful plant/activity in % | | | |
| Example | g ai/ha | ECHCG* | SETVI** | ALOMY*** | PHACA**** |
| Example 1 | 10 g | 90 | 85 | 40 | 70 |
| Comp. ex- | 10 g | 85 | 70 | 20 | 45 |
| ample 1 | | | | | |

*= Echinocloa crus-galli (common barnyardgrass)
**= Setaria viridis (L) (green panicgrass)
***= Alopecurus myosuroides Huds. (slender foxtail)
****= Phaldris canariensis L (canarygrass)

The herbicide formulation according to the invention exhibits a higher activity at a reduced application rate.

### Use Example 2

### Tank Mixes with Dicamba

Spray liquors were prepared from herbicide formulations according to the invention and commercially available clodinafop-propargyl formulations, and the stated amounts of dicamba were added.

The efficacy was determined on the stated harmful plants, proceeding analogously to Use example 1 (Table 3).

TABLE 3

| | | Harmful plant/activity in % | | | | | | | |
|---|---|---|---|---|---|---|---|---|---|
| | Application rate | TRZAW Cubus | TRZAW Cubus | TRZAS Monsun | TRZAS Monsun | ALOMY | ALOMY | AVEFA | AVEFA |
| Example | g Ai/ha | 8 | 21 | 8 | 21 | 8 | 21 | 8 | 21 |
| TOPIK ® 240 | 20 + 200 | 20 | 15 | 20 | 10 | 35 | 90 | 30 | 75 |
| EC* + | 10 + 200 | 20 | 15 | 20 | 10 | 30 | 90 | 25 | 30 |
| DICAMBA | 5 + 200 | 15 | 25 | 20 | 10 | 25 | 60 | 10 | — |
| (Comparative | 2.5 + 200 | 10 | 30 | 10 | 0 | 15 | 15 | 10 | 0 |
| example 2) | | | | | | | | | |
| TOPIK ® 80 | 20 + 200 | 25 | 30 | 25 | 15 | 45 | 95 | 30 | 75 |
| EC** + | 10 + 200 | 15 | 30 | 15 | 15 | 35 | 95 | 20 | 40 |
| DICAMBA | 5 + 200 | 10 | 15 | 15 | 10 | 30 | 85 | 15 | 10 |
| (Comparative | 2.5 + 200 | 10 | 10 | 15 | 10 | 20 | 15 | 10 | 0 |
| example 3) | | | | | | | | | |
| Example 1 + | 20 + 200 | 20 | 35 | 25 | 15 | 30 | 95 | 35 | 75 |
| DICAMBA | 10 + 200 | 15 | 20 | 20 | 15 | 20 | 90 | 40 | 70 |
| | 5 + 200 | 15 | 15 | 25 | 15 | 20 | 85 | 20 | 40 |
| | 2.5 + 200 | 10 | 10 | 20 | 0 | 15 | 50 | 10 | 0 |
| Example 2 + | 20 + 200 | 25 | 15 | 20 | 0 | 45 | 98 | 45 | 95 |
| DICAMBA | 10 + 200 | 25 | 10 | 25 | 5 | 25 | 90 | 90 | 75 |
| | 5 + 200 | 25 | 5 | 25 | 10 | 10 | 60 | 60 | 50 |
| | 2.5 + 200 | 25 | 5 | 30 | 15 | 15 | 25 | 25 | 20 |

*Commercial product from Syngenta (240 g/l clodinafop-propargyl + 60 g/l cloquintocet-mexyl)
**Commercial product from Syngenta (80 g/l clodinafop-propargyl + 60 g/l cloquintocet-mexyl)
TRZAW = Triticum aestivum L (winter wheat)
TRZAS = Triticum aestivum L (spring wheat)
ALOMY = Alopecurus myosuroides HUDS (slender foxtail)
AVEFA = Avena fatua L (wild oat)

The herbicide formulations according to the invention display a significantly reduced antagonism on coapplication with dicamba.

### Use Example 3

Combination of herbicide formulations according to the invention and commercially available clodinafop-propargyl formulations (TOPIK® 240EC) with dicamba/tritosulfuron (ARRAT®) applied post-emergence (Table 4).

TABLE 4

Harmful plants/% activity

| Example | CHEAL | POLAV |
|---|---|---|
| TOPIK ® 240 EC* | <5 | <5 |
| 40 g ai/ha | | |
| TOPIK ® 240 EC | 70 | 48 |
| 40 g ai/ha + ARRAT ®** | | |
| 0.15 kg fp/ha | | |
| Example 1 | <5 | <5 |
| 40 g ai/ha | | |
| Example 1 | >90 | >90 |
| 40 g ai/ha + ARRAT ®** | | |
| 0.15 kg fp/ha | | |

*Commercial product from Syngenta (240 g/l clodinafop-propargyl + 60 g/l cloquintocet-mexyl)
**Commercial product from BASF SE (250 g/kg tritosulfuron + 500 g/kg dicamba)
CHEAL = Chenopodium album (common lambsquarters)
POLAV = Polygonum aviculare L (prostrate knotweed)

The experiments demonstrate that the herbicide formulation according to the invention of Example 1 has a synergistic effect on a mixture of dicamba and tritosulfuron.

1-15. (canceled)

16. A herbicide formulation comprising
a1) at least one herbicidal active substance from the class of the ACC inhibitors;
a2) optionally one or more safeners;
a3) optionally one or more further herbicidal active substance other than (a1) and (a2);
b) one or more solvents of formula (I),
R—CO—NR¹R² (I)
in which
R is a C₃-C₁₈-hydrocarbon radical,
R¹, R² are identical or different and are a C₁-C₁₄-hydrocarbon radical or a C₁-C₁₄-hydroxyhydrocarbon radical;
c) one or more aromatic solvents;
d) one or more surfactants from the group C₈-C₂₂-alkyl alcohols which are alkoxylated, with the terminal hydroxyl groups of these compounds optionally being capped by an alkyl, cycloalkyl, acyl or carboxylate radical having 1-24 carbon atoms;
e) one or more emulsifiers;
f) optionally one or more auxiliaries and
g) optionally water.

17. The herbicide formulation as claimed in claim 16, comprising the components (a1)-(f) in the following amounts (% by weight):
(a1) 2-30,
(a2) 0-10,
(a3) 0-50,
(b) 5-60,
(c) 5-60,
(d) 5-60,
(e) 3-30 and
(f) 0-20.

18. The herbicide formulation as claimed in claim 16, wherein the ACC inhibitor is a phenoxypropionate.

19. The herbicide formulation as claimed in claim 18, wherein the phenoxypropionate is clodinafop-propargyl.

20. The herbicide formulation as claimed in claim 19, wherein component (a2) is cloquintocet-mexyl.

21. The herbicide formulation as claimed in claim 18, wherein the solvent (b) is selected from the group consisting of decanoic acid dimethylamide and mixtures of C₈/C₁₀-fatty acid dimethylamides and dodecanoic acid dimethylamide.

22. The herbicide formulation as claimed in claim 16, wherein the solvent (c) is selected from the group consisting of toluene, xylenes, naphthalene derivatives, mixtures of C₆-C₁₆-aromatics, chlorobenzene and anisaldehyde acetals.

23. The herbicide formulation as claimed in claim 16, comprising alkyl alkoxylates of the formula (II),
R³—O—[R⁴O]ₘR⁵ (II)
where
R³ is a linear or branched, saturated or unsaturated (C₈-C₂₂)-hydrocarbon radical which is unsubstituted or substituted by one or more hydroxyl groups;
R⁴ is an ethylene, propylene or butylene group or a mixture of two or three of the abovementioned groups;
R⁵ is H, (C₁-C₂₄)-alkyl, (C₂-C₂₄)-acyl, (C₃-C₈)-cycloalkyl, and
m is a natural number from 3 to 100.

24. The herbicide formulation as claimed in claim 16, wherein the emulsifier component (e) comprises at least one ionic (e1) and at least one nonionic emulsifier (e2).

25. The herbicide formulation as claimed in claim 24, comprising one or more ionic emulsifiers (e1) is selected from the group consisting of alkali metal, alkaline-earth metal or ammonium salts of the fatty acids, alkyl sulfates, alkyl ether sulfates, alkyl- or isoalkylsulfonates, alkylbenzenesulfonates, and alkylmethyl ester sulfonates and taurates, and one or more nonionic emulsifiers (e2) selected from the group consisting of corn oil ethoxylates, castor oil ethoxylates, tallow fat ethoxylates, glycerol esters, fatty alcohol alkoxylates and oxoalcohol alkoxylates, fatty acid alkoxylates, and alkylphenol alkoxylates.

26. A process for the preparation of a herbicide formulation as claimed in claim 16, wherein the components mentioned are mixed with each other.

27. A method of controlling undesired vegetation, wherein an effective amount of a herbicide formulation according to claim 16 is applied to the undesired plants or the loci where they occur.

28. The method as claimed in claim 27, wherein the formulation is applied together with at least one further herbicide.

29. The method as claimed in claim 28, wherein the further herbicide is dicamba.
